(19) United States
(12) Patent Application Publication
(10) Pub. No.: US 2021/0060885 A1
(43) Pub. Date: Mar. 4, 2021

(54) TIRE WITH NO BEAD TURNUP

(71) Applicant: The Goodyear Tire & Rubber Company, Akron, OH (US)

(72) Inventors: Gilles Reichling, Vichten (LU); Gilles Bonnet, Niederfenlen (LU); Philippe Joseph Auguste Muller, Champlon (BE); Robert Edward Lionetti, Bereldange (LU); Olivier Di Prizio, Hettange-Grande (FR); Nicolas Soultis, Freylange (BE); Frederic Marie Bernard Marechal, Selange (BE)

(21) Appl. No.: 16/945,959

(22) Filed: Aug. 3, 2020

Related U.S. Application Data
(60) Provisional application No. 62/893,639, filed on Aug. 29, 2019.

(51) Int. Cl. B29D 30/32; B60C 15/06

(52) U.S. Cl. CPC B29D 30/32; B29D 2030/3207; B29D 2030/3214; B60C 15/06

(57) ABSTRACT

A tire having no ply turnup is described. The tire includes a tread, a single layer of ply, and a first triangular shaped bead, wherein the radially inner end of the single layer of ply is secured between the first bead and a second bead, wherein the second bead is formed by spirally winding a strip of reinforcements onto the radially inner end of the ply, wherein the strip is formed of two or more parallel reinforcements.

### FIELD OF THE INVENTION

The invention relates generally to tires and more particularly to a pneumatic tire.

### BACKGROUND OF THE INVENTION

For high performance and ultra-high performance tires, it is often desired to eliminate the ply turnup around the bead. Eliminating the ply turnup removes the stress concentration and improves the ply line in the lower area of the tire. Further, if the bead has no ply turnup, there is increased design flexibility for tire/rim interface improvement. However, it is difficult to build the tire without building the tire on a solid core. The ply cord typically pulls out from the bead during the tire curing process, because of the rapid expansion of the tire carcass during the cure process. The solid core eliminates the movement of the carcass. However, building a tire on a solid core requires special equipment and often is a much slower tire building process. Thus, it is desired to provide a tire that has no ply turnup using conventional tire building equipment.

### Definitions

“Aspect ratio” of the tire means the ratio of its section height (SH) to its segment width (SW) multiplied by 100 percent for expression as a percentage.

“Axial” and “axially” means lines or directions that are parallel to the axis of rotation of the tire.

“Chafer” is a narrow strip of material placed around the outside of a tire bead to protect the cord plies from wearing and cutting against the rim and distribute the flexing above the rim.

“Circumferential” means lines or directions extending along the perimeter of the surface of the annular tread perpendicular to the axial direction.

“Equatorial Centerplane (CP)” means the plane perpendicular to the tire's axis of rotation and passing through the center of the tread.

“Footprint” means the contact patch or area of contact of the tire tread with a flat surface at zero speed and under normal load and pressure.

“Groove” means an elongated void area in a tire dimensioned and configured in segment for receipt of an air tube therein.

“Inboard side” means the side of the tire nearest the vehicle when the tire is mounted on a wheel and the wheel is mounted on the vehicle.

“Lateral” means an axial direction.

“Lateral edges” means a line tangent to the axially outermost tread contact patch or footprint as measured under normal load and tire inflation, the lines being parallel to the equatorial centerplane.

“Outboard side” means the side of the tire farthest away from the vehicle when the tire is mounted on a wheel and the wheel is mounted on the vehicle.

“Radial” and “radially” means directions radially toward or away from the axis of rotation of the tire.

“Rib” means a circumferentially extending strip of rubber on the tread which is defined by at least one circumferential groove and either a second such groove or a lateral edge, the strip being laterally undivided by full-depth grooves.

“Sipe” means small slots molded into the tread elements of the tire that subdivide the tread surface and improve traction, sipes are generally narrow in width and close in the tires footprint as opposed to grooves that remain open in the tire's footprint.

“Tangent delta”, or “tan delta,” is a ratio of the shear loss modulus, also known as G″, to the shear storage modulus (G′). These properties, namely the G′, G″ and tan delta, characterize the viscoelastic response of a rubber test sample to a tensile deformation at a fixed frequency and temperature, measured at 100° C.

“Tread element” or “traction element” means a rib or a block element defined by a shape with adjacent grooves.

“Tread Arc Width” means the arc length of the tread as measured between the lateral edges of the tread.

### BRIEF DESCRIPTION OF THE DRAWINGS

The invention will be described by way of example and with reference to the accompanying drawings in which:

FIG. 1 is a cross-sectional view of a tire with no bead turnup; and

FIG. 2 is a close-up view of the bead area of the tire of FIG. 1.

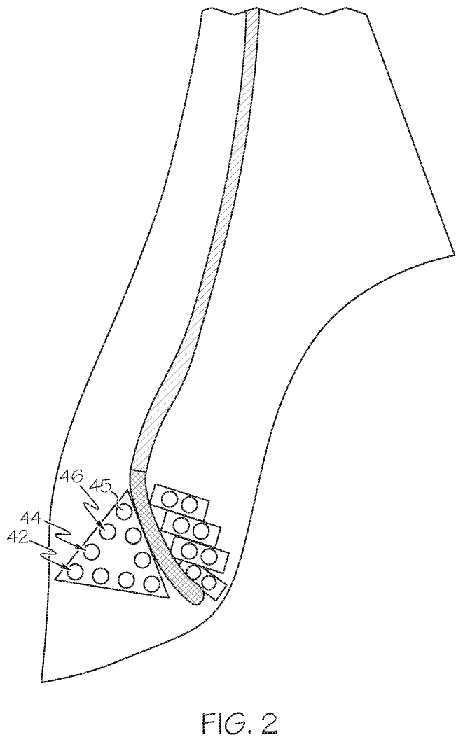

### DETAILED DESCRIPTION OF THE PRESENT INVENTION

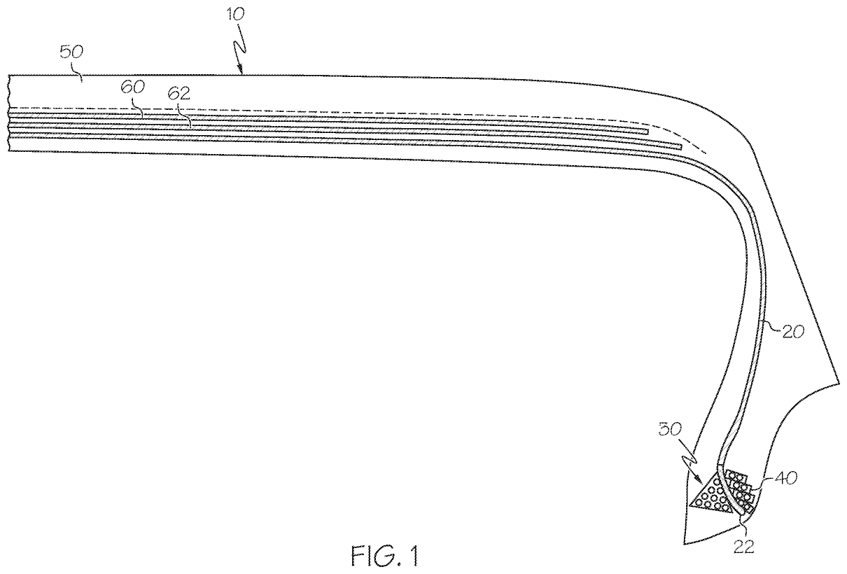

FIG. 1 illustrates a tire 10 of the present invention that has no bead turnup. The tire 10 may further include a tread 50, and belts 60,62. The belts 60,62 may comprise conventional belt configurations known to those skilled in the art.

The tire 10 has a single layer or monolayer of ply 20, that has a radially inner portion 22 that is clamped between a first bead 30 and a second bead 40. The ply layer 20 is comprised of radial cords that may preferably be formed of high modulus 2200/3 denier cords or 3340/2 denier cords. The cord material may be nylon, aramid, or a hybrid construction of nylon/aramid. The lower ply end 22 is clamped between the first bead 30 and the second bead 40. The first bead 30 is a triangular shaped bead. The triangular shaped bead preferably has at least three rows of reinforcement wires, and more preferably four rows of reinforcement wires. The radially innermost row 42 typically has at least four reinforcement wires, while the adjacent third row 44 has three reinforcement wires. The second row 46 has two reinforcement wires, and the first row 48 or radially outermost row has a single reinforcement wire. The reinforcement wire of rows one through four 42,44,46,48 are preferably the same size. The reinforcement wire of the first bead 30 is preferably a 1.3 mm metal wire or with a diameter ranging from 0.8 to 1.5 mm. Preferably, the metal wires of the first bead 30 have a minimum elongation to break of 6% as measured by ASTM D4975-14. The first bead 30 may be pre-formed and then applied onto the tire building drum. An optional first apex 32 may be positioned radially outward of the first bead column 30.

The tire further includes a second or axially outer bead 40 that functions to clamp the ply ending 22 between the first and second beads 30,40. The axially outer bead 40 is a flexible bead formed of multifilament wire. The axially outer bead 40 is formed by winding a strip of parallel reinforcements of two or more wires. The strip is spirally wound directly onto the ply ending 22 during the tire building process, forming multiple layers that are stacked onto each other. Preferably, the reinforcement cables of the strip may be wire with a diameter ranging from 1.0 to 1.8 mm. It is more preferable that the reinforcement cords of the strip are formed from multifilament steel cord reinforcements with a minimum elongation to break of 4% as measured by ASTM D2964-04.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed:

1. A tire having no ply turnup, the tire comprising a tread, a single layer of ply, and a first triangular shaped bead, wherein the radially inner end of the single layer of ply is secured between the first bead and a second bead, wherein the second bead is formed by spirally winding a strip of reinforcements onto the radially inner end of the ply, wherein the strip is formed of two or more parallel reinforcements.

2. The tire of claim 1 wherein the second bead is formed from at least two strip windings of the strip of reinforcements.

3. The tire of claim 1 wherein the triangular shaped bead has at least two layers of reinforcement wires.

4. The tire of claim 1 wherein the triangular shaped bead has at least three layers of reinforcement wires.

5. The tire of claim 1 wherein the triangular shaped bead has a fourth layer of reinforcement wires.

6. The tire of claim 1 wherein the triangular shaped bead is formed of reinforcement wires having a diameter in the range of 0.8 to 1.5 mm.

7. The tire of claim 1 wherein the triangular shaped bead is formed from bead wires with a minimum elongation to break of 6%, as measured by ASTM D4975-14.

8. The tire of claim 1 wherein the reinforcement cords of the strip have a diameter in the range of 1.0 to 1.8 mm.

9. The tire of claim 1 wherein the reinforcement cords of the strip is formed from multifilament steel cord reinforcement, with a minimum elongation to break of 4%, as measured by ASTM D2969-04.
